(19) United States
(12) Patent Application Publication
(10) Pub. No.: US 2007/0144613 A1
(43) Pub. Date: Jun. 28, 2007

(54) Method for engraving and decorating wooden objects

(76) Inventor: Alexander P. Dorofeev, Edmore, MI (US)

Correspondence Address: Timothy S. Stevens, 5108 Foxpoint Circle, Midland, MI, 48642, US

(21) Appl. No.: 11/527,066

(22) Filed: Sep. 26, 2006

Related U.S. Application Data
(60) Provisional application No. 60/720,849, filed on Sep. 27, 2005.

(51) Int. Cl. B27M 1/00

(52) U.S. Cl. 144/329

(57) ABSTRACT

A method for engraving and decorating a wooden object, comprising the step of rotating a rotary cutter in contact with a surface of a wooden object so that the tool advances into the wooden object to produce a machined indentation in the surface of the wooden object, the indentation being burnished and charred. And, an object so engraved and decorated.

### BACKGROUND OF THE INVENTION

This application claims the benefit of priority to US Provisional Patent Application Ser. No. 60/720,849 filed Sep. 27, 2005. The instant invention is in the field of methods for engraving and decorating wooden objects.

The effect of charring and polishing a wooden object due to the friction between the wood, cut off wood debris and a rotating cutting tool is known in the art but is not utilized for engraving and decorating a wooden object. Such charring and polishing is regarded as an indication of a dull cutting tool or an improper feed rate of the cutting tool relative to the wooden object and is considered undesirable. Wood burning is used to engrave and decorate wooden objects. However, the productivity of wood burning is relatively low. Hot branding/impressing is used to engrave and decorate wooden objects. However, hot branding/impressing is a relatively difficult process to control.

### SUMMARY OF THE INVENTION

The instant invention is a new use of the effect of engraving, charring and polishing a wooden object due to the friction between the wood, cut off wood debris and a rotating cutting tool. An object of the present invention to provide a new method of decorating surface of the wooden articles for the purpose of giving such articles a novel appearance. It is another object of the present invention to provide a new and improved method which may be easily and efficiently used and marketed. It is a further object of the present invention to provide a new method for producing a durable decoration of a wooden object. An even further object of the present invention is to provide a new method which is susceptible of a low cost of manufacture with regard to both materials and labor, and which accordingly is then susceptible of low prices of sale of the decorated wooded objects to the consuming public. Still yet another object of the present invention is to provide a new method of decorating wooden tool handles and the like while simultaneously improving anti-slip properties of such handles. Still yet another object of the present invention is to provide a new method of decorating wooden articles utilizing a variety of rotating cutting tools. Another object of the instant invention is a new method of decorating wooden articles, which method can be adopted and utilized by people with limited skills in the art and by persons having reduced physical and mental ability. Another object of the instant invention is to provide a new method of decorating wooden objects which method provides increased productivity and controllability relative to methods used in the prior art.

More specifically, the instant invention is a method for engraving and decorating a wooden object, comprising the step of rotating a rotary cutter in contact with a surface of a wooden object so that the tool advances into the wooden object to produce a machined indentation in the surface of the wooden object, the indentation being burnished and charred. In a related embodiment, the instant invention is a wooden object engraved and decorated by the method of the instant invention.

### BRIEF DESCRIPTION OF THE DRAWINGS

FIG. 1 is a perspective view of a wooden box having penciled layout lines inscribed thereon; and

FIG. 2 is a perspective view of the wooden box of FIG. 1 being engraved and decorated by the method of the instant invention.

### DETAILED DESCRIPTION OF THE INVENTION

The instant invention is a method of decorating wooden objects (including wood compositions such as chip board and plywood) using a rotating tool. The method utilizes simultaneous rotary cutting of an indentation of a predetermined and variable shape in the surface of a wooden article with full or partial charring of the surfaces of the said indentation as well as full or partial polishing of the surfaces of said indentation. The shape of the indentation is determined by the angle of the axis of the rotation of the cutting tool relative to the normal of the surface of the wood in the place of contact and by longitudinal and transverse movement of the rotating cutting tool. The indentations can be arranged in a pictorial, geometrical, floral or other decorative pattern or design. In addition, on some articles the indentations can have a utilitarian purpose of improving grip (such as a tool handle and the like). The articles decorated in accordance with the method of the instant invention have an attractive and novel appearance. The products produced with the use of said method can be incorporated into or may become articles of manufacture and artistic articles. The method of the instant invention doesn't require specialized or expensive tools. Said method can be quickly learned. The method of the instant invention can be used on a variety of wooden articles of any desired size or shape of different types of wood or wood compositions, and with a variety of rotating cutting tools.

It is recommended that any selected rotary cutting tool be used for engraving a selected scrap piece of wood (of the same type as the wooden object to be engraved and decorated) for several minutes prior to work on an object to help determine the ability of a chosen tool to perform the method of the instant invention on a chosen wood. Smoke and charred wooden debris coming from the cutting region indicate a general ability of a tool to produce the effect of the instant invention. Visual examination of the cut surfaces helps make the final determination of the tool's suitability. Such practice helps the operator determine an optimal cutting regime (rotational speed of the tool, cutting speed and rate of advancement of the tool through the wood) and helps make the rotary cutting tool more efficient in producing the desired effect by dulling the cutting elements thereby increasing friction and heat (charring), building a layer of tar and wood debris in the recesses of the tool's cutting teeth (increasing the retention of the debris and an increase in friction and polishing of the engraved portion of the wooden object). The method of the instant invention can be used on a variety of woods with a variety of rotary cutting tools rotating at a variety of speeds. The rotary cutter can be of any shape such as a disk cutter, a cylindrical cutter, a spherical cutter or a spheroidal cutter. The rotary cutter is preferably made of metal but a rotary grinding cutter can also be used in the method of the instant invention, in which case a coarse aluminum oxide grinding cutter is preferred.

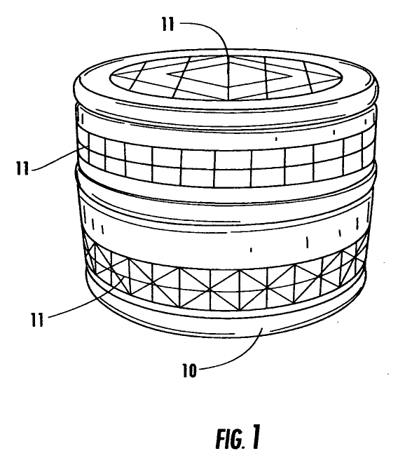

Preferably the work piece is a hard wood with uniformed small grain or fiber. The preferred surface to be engraved is against the grain (end grain or transverse). A means of marking the design on the surface of a work piece (such as the pencil lines shown in FIG. FIG. 1) would not be needed for a program controlled system, such as a CNC system (or other means of controlling tool motion such as a cam or a pattern). A means of work piece fixation (manual, mechanical, hydraulic, electric etc.) is preferred. A rotary cutting tool is preferred (a preferable tool being a cylindrical engraving, boring, milling, carving or grinding bit, preferably having a maximum diameter “D” less than 0.5 inches; with small (relative to D) multiple cutting elements or teeth with defined cutting edges. The rotary cutter is preferably mounted in an electric cutting tool (such as a 35,000 rpm Dremel brand hi speed MultyPro™ tool). The means of relative motion (work piece to tool) can be manual, mechanical, hydraulic or electric etc. The means of controlling the cutting tool can be visual or automatic. The means of optionally cleaning the surface of the engraved and decorated wooden object to remove layout marks and any minor rough edges can be a pencil eraser, wire brush or sand paper and can be mechanized. The finishing of an object engraved and decorated according to the instant invention can optionally include the application of a varnish or a lacquer.

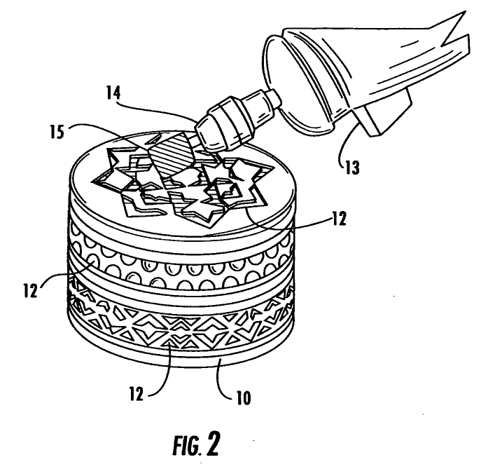

As a specific embodiment, a turned wooden work piece is held (and moved) by one hand. A Dremel brand MultyPro™ set for 25,000 rpm and equipped with the cylindrical 5/16″ hi speed cutter is held (and moved) by the other hand. The cutter's axis of rotation is approximately thirty five degrees to the surface plane of the work and such axis is maintained as the cutter advances into the wood. The rate of advancement of the cutter into the wood is approximately four millimeters per second. Cuts of a desirable angle, depth, lengths and direction are produced in the surface of a work piece in accordance with the marks laid out on the surface of the work piece as shown in FIG. 2. To achieve the desired effect (charring and polishing) the optimal cutting rate is determined visually with the appearance of smoke and charred debris coming from the cutting region and further examination of the cut surfaces. Those skilled in art can use the method on a variety of woods with a variety of rotary cutting tools rotating at a variety of speeds.

Following the engraving of the design, the surface of the work piece (article) is preferably cleaned and finished with varnish or lacquer, or if the work piece is to be incorporated into a manufacture or an artistic article such optional finishing can be performed latter.

It should be understood that to produce the desired effect the teeth of the cutting tool for use in the method of the instant invention are preferably in a dull condition; and the distance between the adjoining teeth and the depth of the recesses between the teeth are preferably relatively small.

Referring again to FIG. 1, therein is shown a drawing of a turned wooden box 10 having penciled layout lines 11 inscribed thereon. Referring again to FIG. 2, therein is shown a drawing of the wooden box 10 of FIG. 1 being engraved and decorated by the method of the instant invention. A high speed hand held tool 13 is shown having a cylindrical cutter 15 mounted in the chuck 14 of the tool 13. The cutter 15 is advanced into contact with the box 10 so that the cutter 15 advances into the box 10 to produce machined indentations 12 in the surface of the box, the indentations being burnished and charred.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

What is claimed is:

1. A method for engraving and decorating a wooden object, comprising the step of rotating a rotary cutter in contact with a surface of a wooden object so that the tool advances into the wooden object to produce a machined indentation in the surface of the wooden object, the indentation being burnished and charred.

2. The method of claim 1, wherein the rotary cutter is advanced into the surface of the wooden object by hand control.

3. The method of claim 1, wherein the rotary cutter is advanced into the surface of the wooden object by machine control.

4. A wooden object engraved and decorated by rotating a rotary cutter in contact with a surface of a wooden object so that the tool advances into the wooden object to produce a machined indentation in the surface of the wooded object, the indentation being burnished and charred.

5. The wooden object of claim 4, wherein the wooden object is a handle.

6. The wooden object of claim 4, wherein the wooden object is a novelty.
